(19) United States
(12) Patent Application Publication
(10) Pub. No.: US 2020/0392041 A1
(43) Pub. Date: Dec. 17, 2020

(54) CLINKER PRODUCTION PLANT AND METHOD FOR PRODUCING CLINKER IN SUCH A PLANT

(71) Applicant: FIVES FCB, VILLENEUVE D'ASCQ (FR)

(72) Inventors: Jean-Michel CHARMET, VILLENEUVE D'ASCQ (FR); Yannick GUIMARD, VILLENEUVE D'ASCQ (FR)

(21) Appl. No.: 16/772,191

(22) PCT Filed: Dec. 13, 2018
(86) PCT No.: PCT/FR2018/053281

§ 371 Date: Jun. 12, 2020

(30) Foreign Application Priority Data
Dec. 15, 2017 (FR) 17 62264

(51) Int. Cl. C04B 7/44; C04B 7/47

(52) U.S. Cl. CPC C04B 7/4446; F27M 2003/03; C04B 7/475

(57) ABSTRACT

Disclosed is a clinker production plant including: a preheating unit; a calcination unit; a kiln; and a cooler. The calcination assembly includes a calcination reactor for calcination by combustion of a solid so-called alternative fuel. The calcination reactor is arranged such that at least part of the combustion fumes from the kiln pass partly through the calcination reactor before entering the preheating unit, and a tertiary gas flow including air leaving the cooler passing at least in part through the calcination reactor before entering the preheating unit. The calcination reactor includes a system for controlling the residence time of the alternative solid fuel.

### BACKGROUND OF THE INVENTION

### Field of the Invention

The invention relates to the field of cement production, and more specifically a process for producing cement clinker.

### Description of the Related Art

FIG. 1 shows a schematic example of a typical clinker production plant 100 for the production of clinker. Plant 100 comprises a preheating and/or precalcining unit 101, generally comprising a preheater 102 and a calciner 103, followed by a clinker kiln 104 and a cooler 105. Raw material is fed to the top of preheater 102. The preheater 102 usually consists of cyclones in series, through which the raw material is passed where it is preheated. The preheated material then passes through calciner 103, where, thanks to the high temperature, it is mostly decarbonated. For example, a burner 106 can be provided in calciner 103. Then, the largely decarbonated material enters kiln 104. Typically, kiln 104 is of the rotary type, and includes a burner 107. The material is fired in kiln 104: its decarbonation continues, then the material is transformed into clinker. The fired material is then cooled in cooler 105. For this purpose, cooler 105 comprises an inlet for a coolant, usually air.

The air heated by the material in cooler 105, containing oxygen, can be recovered for use at different locations in plant 100 to fuel combustion. For example, some of this air, called secondary air, is recovered to be fed into the kiln 104, near the burner 107; another part, called tertiary air, can be fed to the calciner 103, near the burner 106.

The fumes from kiln 105 are used to heat the material before it enters kiln 105. Specifically, the fumes from the kiln enter the calciner 103. Tertiary air, material and fuel are also fed into calciner 103. A combustion reaction then takes place in calciner 103 where the material is at least partially decarbonated.

Burners 106 and 107 are typically fuelled with a fuel whose properties allow it to burn quickly once ignited. Specifically, the fuel properties are adapted to the residence time imposed by the design and dimensions of kiln 105 and precalciner 103. Therefore, such a fuel is chosen so that this residence time allows it to reach its complete combustion before the fumes enter the preheater 2. Thus, the fuel completely volatilizes, ensuring a good yield, and only the resulting ash, of a mineral nature, mixes with the material.

Fuels that meet these criteria are expensive. They are usually fossil fuels, in powder, gas or liquid form. And the production of clinker requires a large consumption of these fuels. Indeed, it is estimated that it takes about 100 kg of fuel to produce 1T of clinker.

It is then known to use less expensive solid alternative fuels. Solid alternative fuels include materials that are waste or biomass. Examples include tyres, plastic parts found in cars, sewage sludge, wood waste and, more generally, any waste from an industry or trade, or even from households.

Compared to fossil fuels, solid alternative fuels are generally available in coarse form, with dimensions of up to 500 mm. They are therefore more difficult to transport in the gaseous stream as they are heavier and take longer to burn, partly because of the larger particle size of alternative solid fuels and their smaller specific surface area. In addition, depending on their origins, alternative coarse fuels have combustion properties that may vary.

One of the problems in the use of alternative solid fuels is therefore to use them in an optimal way, making the most of their calorific value, and obtaining their complete combustion at the right place in a clinker production plant.

In order to allow the use of such fuels in a cement clinker production plant 100 that meets the criteria, it is known to implement a preliminary step of shredding of solid alternative fuels in order to make them reach dimensions compatible with their use. This solution is unsatisfactory because the amount of energy used for shredding and the associated maintenance costs of the shredding devices significantly reduce the attractiveness of using alternative fuels.

Thus, there is a need to use solid alternative fuels in the coarsest possible form, limiting the costs of processing these fuels prior to their use in the clinker production plant.

Several solutions have been proposed in the state of the art.

One solution is to set up an additional reactor, dedicated to the combustion of alternative solid fuels. In general, the purpose of the additional reactor is to burn the alternative fuels completely before they reach the clinker kiln, so that only the ashes from the combustion, which are mineral in nature, reach the kiln. These ashes are then integrated into the material to form clinker.

Document DE3320670 proposes the installation of such a fluidized bed kiln type reactor to burn the waste in a cement clinker production process.

The solution proposed in this document is not completely satisfactory, as its technological implementation is complicated. In particular, fluidised bed technology does not allow the use of solid fuels of any size, uncontrolled, and in particular of large dimensions such as the above-mentioned alternative solid fuels.

Document DE3218232 proposes to set up a reactor for the combustion of waste, the fumes generated by this combustion being fed to the inlet of the preheater. The residues from the combustion of the alternative solid fuel are recovered in a silo to be mixed downstream of the clinker kiln with clinker and gypsum in adjustable proportions to obtain cement. Thus, the quality of the cement can be adjusted as well. However, such a system requires more energy than the conventional process described above, and is therefore more expensive to implement. Indeed, the combustion chamber of the pyrolysis kiln requires additional energy input.

Document WO01/09548 proposes to burn alternative fuels in a compartment, including a rotating support to adjust the residence time of the fuels. Air from the cooler is sent to the compartment to supply it with oxygen. The fumes from the kiln are sent directly to the calciner, without passing through this compartment.

However, the rotating support does not stir the fuel sufficiently to prevent hot spots, so operating problems may occur.

U.S. Pat. No. 6,626,662 describes a rotating drum type reactor for burning coarse alternative fuel. For this purpose, the rotating drum is fed on the one hand with tertiary air, i.e. air from the cooler, and on the other hand with raw material and an alternative fuel. Another fuel, easily flammable, is also introduced into the drum to ignite the alternative fuel. Combustion control is achieved by varying the amount of raw material fed into the drum. The solid residues, comprising precalcined raw material, can be fed either directly to the inlet of the clinker kiln if they are large, or into an ascending branch of a precalcining system. Therefore, some of the material is used as a means of controlling the combustion of the alternative fuel in the rotating drum.

However, in the kiln, nitrogen and its compounds, brought in particular by primary and secondary air, and also by the fuel, tend to oxidise and form nitrogen oxides (known as NOx) which are highly polluting and whose atmospheric emissions are limited by regulations. In a known way, the NOx contained in the kiln fumes are reduced in the combustion chambers of the precalcining unit.

However, none of the state of the art facilities propose to control this reduction.

A suitable calcining process and device for using an alternative fuel in the manufacture of cement clinker is still known from US document 2009/0283015.

In this entrained-flow type calciner, conventional fuel (non-coarse and non-alternative) is fed at the injection points marked 12, the air required for combustion coming from tertiary air, the entraining gas flow coming from the kiln fumes of a cement clinker manufacturing plant.

In addition, this device allows operation with an alternative fuel, by means of an endless screw passing through the wall of a vertical pipe of the device, and feeds a calcination reactor dedicated to the alternative fuel, comprising a combustion chamber formed by a shovel, projecting from the wall towards the centre, forming an obstacle to the rising gas flow from the kiln fumes. A combustion air supply system, deliberately distinct from that for the combustion of conventional fuel (and using tertiary air) comprises nozzles, marked 19, at the bottom of the shovel, implicitly intended to ensure a certain fluidisation of the alternative fuel in the cavity forming the combustion chamber.

According to the claimant's findings, due to the pressure losses generated by the nozzles of the supply system necessary for the fluidisation of the alternative fuel, it is necessary to push the air (through the use of fans, blowers, or equivalent), as these devices have operating temperature limits, typically of the order of 400° C., i.e., a temperature much lower than that of tertiary air. Ultimately, such a design prohibits the use of warmer air (such as tertiary air) for the combustion of the alternative fuel. The fluidisation necessary for the combustion of the fuel in the chamber also requires a certain operating flow rate, making it impossible to adjust the air for the combustion of the alternative fuel, and in order to obtain a reduction in NOx. Such a design is also not optimal in terms of reducing the NOx produced by the kiln.

### SUMMARY OF THE INVENTION

There is therefore a need for a new cement clinker production plant using alternative fuels that overcome in particular the above-mentioned disadvantages.

For this purpose, a first object of the invention is to use coarse solid alternative fuels in a cement clinker production plant by controlling their combustion.

A second object of the invention is to use coarse solid alternative fuels in a cement clinker production plant by optimising energy costs.

A third object of the invention is to use coarse solid alternative fuels in a cement clinker production plant by increasing control over appearing pollutants.

A fourth object of the invention is to use coarse solid alternative fuels in a cement clinker production plant by optimising the use of their calorific power.

A fifth object of the invention is to use coarse solid alternative fuels in a cement clinker production plant which does not increase production costs.

A sixth object of the invention is to use coarse solid alternative fuels in a cement clinker production plant which does not degrade the quality of the cement made from the clinker obtained in that plant.

Thus, according to a first aspect, the invention proposes a clinker production plant comprising:
a preheating assembly, in which raw material is preheated;
a calcination unit, in which the preheated raw material is at least partially decarbonated;
A kiln in which the preheated and at least partially decarbonated raw material is baked;
a cooler in which the fired kiln material is cooled by cooling air.

The calcination assembly comprises a calcination reactor by combustion of a so-called alternative solid fuel. Said calcination reactor is arranged, depending on the direction of gas flow, between the preheating unit on the one hand and the kiln on the other hand, and is connected to the cooler in such a way that:
at least part of the combustion fumes from the kiln pass at least partly through the calcination reactor before entering the preheating assembly,
a tertiary gas flow comprising at least in part air leaving the cooler passes at least in part through the calcination reactor before entering the preheating assembly.

The calcination reactor also includes a system for controlling the residence time of the alternative solid fuel in the calcination reactor.

The plant allows the burning of solid alternative fuels of larger dimensions than those usually used in the kiln or calcination assembly, while providing control over the reduction of NOx contained in the kiln fumes that pass through the calcination reactor.

For this purpose, a tertiary flow rate adjustment system is configured to ensure a balance in the calcination reactor between the supply of oxygen required for the combustion reaction and the reduction of NOx contained in the kiln fumes.

For example, the calcination reactor is a rotary kiln, where the alternative solid fuel residence time control system is a system for controlling the rotational speed and/or slope of the calcination reactor.

Solid alternative fuel can be a solid fuel comprising particles with a characteristic size greater than 20 mm, reducing the energy costs required in a shredding operation.

The installation can then easily be adapted to different types of fuel, in addition to coarse alternative solid fuels.

Thus, according to an embodiment, the calcination unit may also include an additional calcination reactor fuelled by a fuel. The additional calcination reactor is arranged between the calcination reactor and the preheating assembly, so that at least part of the flue gas leaving the calcination reactor passes through the additional calcination reactor before entering the preheating assembly. The additional reactor is therefore particularly suitable for using conventional fuels when these are available for the plant's supply.

According to an embodiment, the calcination assembly may also comprise an auxiliary calcination reactor, fed with a fuel, the auxiliary reactor being connected to the cooler upstream of the calcination reactor, so that the tertiary gas flow feeding the calcination reactor comprises at least part of the fumes leaving the auxiliary reactor. Such an auxiliary reactor makes it possible to use fuels that are difficult to ignite.

According to a second aspect, the invention concerns a process for the production of clinker in an installation as presented above, said process comprising:
preheating the raw material in the preheating unit;
the decarbonation of the preheated material in the calcination unit;
baking the preheated and decarbonated material in the kiln;
cooling in the cooler of the fired material, the cooling being carried out by means of cooling air.

The process further comprises:
feeding the calcination reactor with at least part of the kiln fumes and a tertiary gas stream comprising at least part of the cooling air leaving the cooler;
the combustion in the calcination reactor of a solid alternative fuel and the adjustment of the residence time of the solid alternative fuel in the calcination reactor;
the recovery of fumes from the calcination reactor to feed the preheating assembly.

Solid alternative fuel can be a solid fuel comprising particles with a characteristic size greater than 20 mm or even greater than 80 mm.

Advantageously, the tertiary gas flow to the calcination reactor can be controlled so as to achieve a balance between the supply of oxygen needed for the combustion reaction and the reduction of NOx produced in the kiln.

### BRIEF DESCRIPTION OF THE DRAWINGS

Other features and advantages will become apparent in the light of the description of the embodiments of the invention accompanied by the figures in which:

FIG. 1 is a diagram illustrating a cement clinker production plant using a state-of-the-art embodiment;

FIG. 2 is a diagram illustrating a cement clinker production plant using according to a first embodiment of the invention;

FIG. 3 is a diagram illustrating a cement clinker production plant using according to a second embodiment of the invention;

FIG. 4 is a diagram illustrating a cement clinker production plant using according to a third embodiment of the invention; and

FIG. 5 is a diagram illustrating a cement clinker production plant using according to a fourth embodiment of the invention.

### DESCRIPTION OF THE PREFERRED EMBODIMENTS

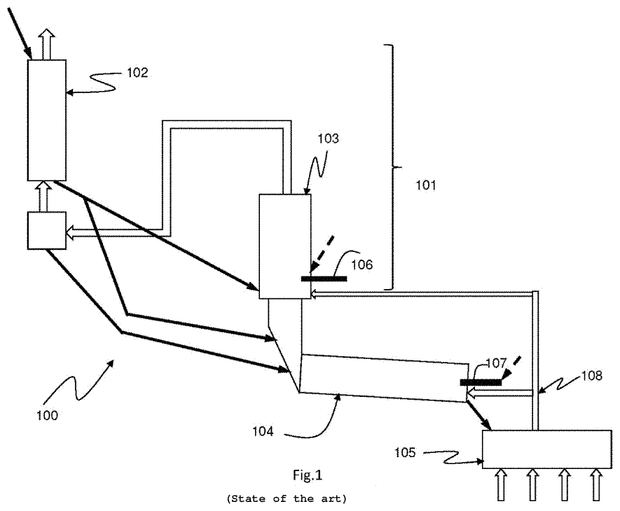

FIG. 1, which represents a state of the art, has already been described above.

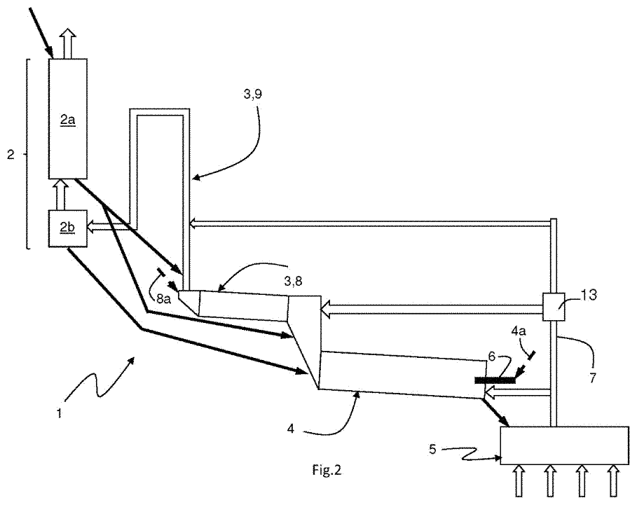

FIGS. 2 to 5 show four embodiments of a cement clinker production plant 1.

In a classical way, and following generally the direction of the material flow, the plant 1 includes:
a preheating unit 2, in which the raw material is preheated and at least partially decarbonated;
a calcination unit 3, in which the preheated raw material is at least partially decarbonated;
a kiln 4 in which the preheated and at least partially decarbonated raw material is baked;
a cooler 5 in which the fired kiln 4 material is cooled by cooling air.

Specifically, the preheating unit 2 comprises a plurality of cyclones, e.g. five, arranged in series, in which the material is carried from cyclone to cyclone by a carrier gas from the calcination unit 3. In FIGS. 2 to 5, the preheating unit 2 has been represented by a first block 2a representing the first cyclones, and a second block 2b representing the last cyclone(s), in order to facilitate the description that follows.

Kiln 4 is, for example, a rotary kiln, the material feed in kiln 4 to the cooler 5 being controlled by the rotation and/or inclination of kiln 4. A burner 6 is provided in kiln 4, on the side opposite to the material feed into kiln 4. This burner is fuelled by a conventional 4a fuel, i.e. by a fossil fuel or an alternative fuel in liquid or gaseous form, or by a solid alternative fuel treated so as to have characteristic particle sizes of less than 20 mm. The kiln flame generated by burner 6 is supplied with so-called primary air, i.e. air from outside the plant injected via burner 6, and is also supplied with so-called secondary air, i.e. heated air from the cooler 5.

For this purpose, cooler 5 has a cooling air inlet. This air is heated by the hot cooked material with which it comes into contact in the cooler. In order to take advantage of this heated air, some of it is recovered and sent to kiln 4 as secondary air. It can also be sent for another part to the calcination unit 3 as tertiary air.

As shown in FIGS. 2 to 5, the secondary and tertiary air are taken from the same location, in this case at the heating hood on cooler 5, so that a single distribution sheath 7 supplies the secondary and tertiary air. Of course, it can be otherwise, as the tertiary air intake can be made at a point on the cooler 5 where the heated cooling air is cooler than the secondary air taken from the heating hood.

According to the invention, the calcination unit 3 comprises a calcination reactor 8 which is arranged between the kiln 4 and the preheater 2 in the direction of flow of the fumes in plant 1, so that at least some, and preferably all, of the fumes leaving the kiln enter the calcination reactor 8 before entering the preheater 2.

In what follows, the positions of the equipment, and in particular the terms “upstream” and “downstream”, shall be understood, unless otherwise specified, in relation to the direction of flow of the gases in installation 1.

The calcination reactor 8 may include, but is not necessarily limited to, a burner. However, the fumes from furnace 4 are generally hot enough, at a temperature of around 1100° C., to provide the energy needed to burn the coarse alternative solid fuel in reactor 8. Recycling the energy of the flue gas from kiln 4 into the calcination reactor 8 thus reduces the energy costs of plant 1.

The calcination reactor 8 is also connected, directly or indirectly, to the distribution duct 7, so that it is fed by a so-called tertiary gas flow coming from cooler 5. Specifically, as will be explained later, the tertiary gas stream includes at least some tertiary air. This tertiary flow provides the oxygen necessary for the combustion reaction.

Calcining reactor 8 has a fuel inlet 8a. According to the invention, it is a coarse alternative solid fuel. The term “coarse” is used here to refer to a particle size larger than that of the solid fuels normally used. In particular, a coarse alternative solid fuel here comprises particles with at least one characteristic size greater than or equal to 20 mm (millimetres), and preferably greater than or equal to 80 mm. The particles of the coarse alternative solid fuel injected into the calcination reactor 8 can reach characteristic dimensions of around 500 mm, so that any preliminary shredding operation involves much lower costs than the shredding operations mentioned in the introduction for the state of the art.

The calcination reactor 8 also includes a system for adjusting the residence time of the coarse alternative solid fuel: the residence time is adjusted so that the fuel is completely consumed, so that only mineral residues fall into kiln 4 and mix with the material.

According to a particular embodiment, which is the one shown in the figures, the calcination reactor 8 is a rotary kiln. The residence time of the fuel can then be adjusted by two parameters: the inclination of reactor 8 and the rotation speed. The feeding of coarse alternative solid fuel into the calcination reactor 8 is then preferably done on the highest side, so that the fuel has the whole length of the calcination reactor 8 to burn out and only ashes reach the lowest point of the calcination reactor 8, before falling into the clinker kiln 4.

The fuel residence time adjustment system makes it possible to adapt the residence time in particular according to the nature of the coarse alternative solid fuel supplied. This is because coarse alternative solid fuel can have different origins, and therefore different combustion properties in different batches. The particle size of the alternative solid fuel may also vary depending on its origin. It is therefore advantageous to be able to adjust the residence time in the calcination reactor 8 in order to always achieve complete combustion of the coarse alternative fuel.

Preferably, the tertiary flow rate is adjusted to achieve a balance between the oxygen supply needed for the combustion reaction and the need to reduce the NOx produced in the kiln 4.

Indeed, conditions in kiln 4 are favourable to the appearance of NOx, which are highly polluting pollutants. In order to reduce NOx, and to further avoid their occurrence in the calcination reactor 8, the amount of oxygen arriving through the tertiary flow is controlled.

Preferably, the fumes from kiln 4 and the tertiary air flow mix upstream or at the inlet of the calcination reactor 8, so that the NOx reduction mechanism of the fumes from kiln 4 is controlled by the tertiary flow rate. The amount of NOx leaving plant 1 is thus advantageously limited. The control of the proportion of the tertiary flow feeding the calcination reactor 8 is such that the alternative fuel is subjected in the reactor to the high temperatures of the fumes from the kiln, in order to cause first of all at least the partial volatilisation of the alternative fuel, in a reducing atmosphere, and thus the release of pyrolysis products (from the alternative fuel) which recombine by reaction with NO to be transformed into N2, thus ensuring the reduction of NOx.

The combustion of the alternative fuel is then carried out in the same calcination reactor 8 using oxygen from tertiary air. The calcination reactor 8 thus makes it possible to combine both the control of the combustion of a coarse alternative solid fuel and the control of the reduction of NOx contained in the fumes of kiln 4.

For this purpose, the installation includes a tertiary flow rate adjustment system 13, which may include dampers and/or valves, to control the proportion of tertiary air arriving at the calcination reactor 8.

This adjustment system 13 is configured to ensure a slightly reducing atmosphere in the calcination reactor, allowing both the correct combustion of the solid alternative fuels and the reduction of the NOx produced by the kiln.

Four embodiments of this invention will now be described in detail.

According to a first embodiment illustrated in FIG. 2, the tertiary flow comprises only tertiary air, the calcination reactor 8 being directly connected to the distribution sheath 7.

The calcination reactor 8 is followed, downstream in the direction of gas flow, by a sheath 9 called gooseneck, in which the calcination of the material continues under the effect of the residual heat in the gases passing through gooseneck 9. Possibly, as shown in FIG. 2, tertiary air may be fed into gooseneck 9 to support combustion. The adjustment system 13 allows the proportion of tertiary air supplied to the inlet of the calcination reactor 8 to be adjusted, and the remaining proportion to be supplied downstream, for example a little further into the calcination reactor 8, or even downstream of the calcination reactor 8, for example in the gooseneck 9, and as shown in FIG. 2.

Specifically, material leaving the first block 2a of preheater 2 is suspended in the rising gas flow circulating through the gooseneck 9. This material is transported by the fumes and gases from kiln 4 and calcination reactor 8 to the second block 2b of preheater 2. The material is then sent to the inlet of the clinker kiln 4.

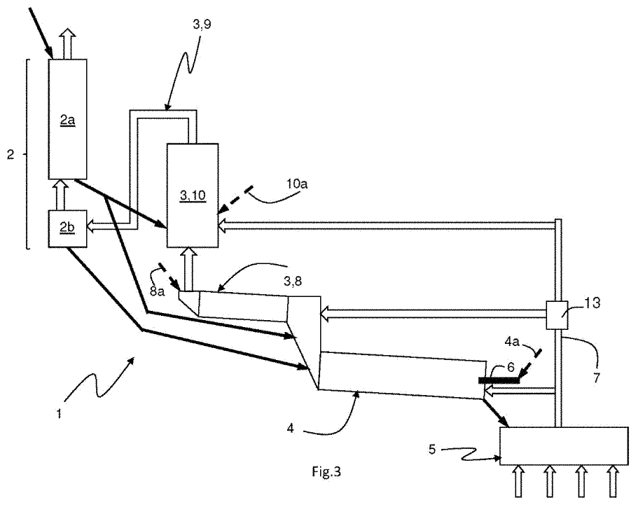

According to a second embodiment illustrated in FIG. 3, compared to the first embodiment, the calcination unit 3 includes an additional calcination reactor 10 between calcination reactor 8 and gooseneck 9. Thus, the fumes from calcination reactor 8 enter, at least in part and preferably completely, into the additional reactor 10, pass through the gooseneck 9 and enter the preheater 2. The additional reactor 10 includes in particular an inlet 10a for a conventional fuel as defined above. An additional tertiary air supply can also be provided in the additional reactor 10 to feed the combustion. This additional reactor 10 therefore makes it possible to consume conventional fuels when these are available to supplement the energy input required to achieve the targeted level of decarbonation of the material.

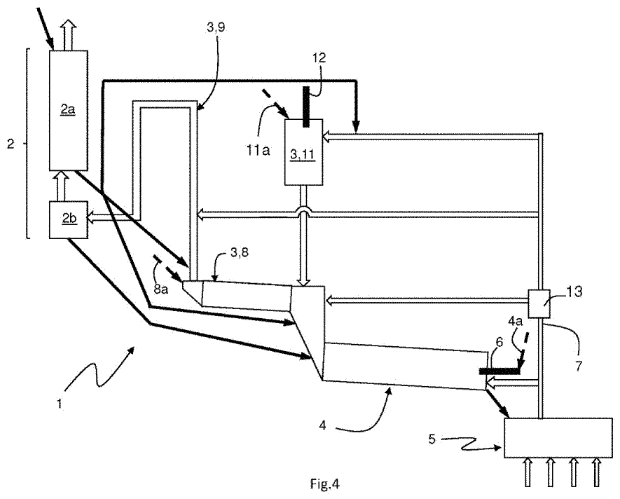

According to a third embodiment illustrated in FIG. 4, compared to the first embodiment, the calcination unit 3 comprises an auxiliary reactor 11, connected to the distribution sheath 7, upstream of the calcination reactor 8 according to the direction of gas flow. A burner 12 is used to ignite a fuel supplying in 11a the auxiliary reactor 11.

For example, when the available fuel is difficult to ignite, in particular because it contains little volatile matter, it is preferable to ignite the fuel in such a dedicated auxiliary reactor 11, in which the energy and the quantity of oxygen, contained in the tertiary air arriving through the distribution sheath 7, which are necessary for combustion, are supplied to ensure stable and controlled combustion.

The gases coming out of the auxiliary reactor 11, mixed with combustion fumes and tertiary air, then form the tertiary gas flow which is sent to the inlet of the calcination reactor 8, where it mixes with the fumes from kiln 4.

As in the first embodiment, the fumes from calcination reactor 8 pass through a gooseneck 9, carrying the material to be calcined, and then arrive at preheater 2 where they preheat the material before leaving plant 1.

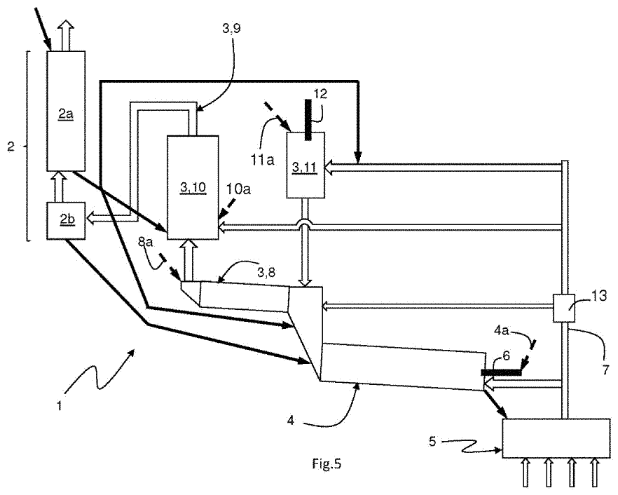

In a fourth embodiment, shown in FIG. 5, the plant includes an additional calcination reactor 10 in the second embodiment, and an auxiliary calcination reactor 11 in the third embodiment, to combine their effects and benefits.

The clinker production plant 1 thus described offers great flexibility in the use of fuels. Indeed, depending on the nature and origin of the fuels available for plant 1, the different reactors 8, 10 and 11 can be used, adapting the proportions of the different fuels and material arriving at reactors 8, 10 and 11 according to energy requirements.

Plant 1 thus described makes it possible in particular to use alternative solid fuels in coarse form in a cement clinker manufacturing process, without any prior fuel shredding step, in an efficient manner thanks in particular to the control of the fuel residence time in the calcination reactor 8, and thanks to the use of fumes from the clinker kiln 4 and tertiary air from the cooler 7.

Plant 1 also reduces the need for a cleaning step to remove NOx from the kiln fumes. Indeed, the position of the calcination reactor 8 in the fume path of kiln 4, combined with the control of the oxygen supply to the calcination reactor 8, creates the right conditions to obtain a NOx reduction reaction.

The amount of energy consumed by plant 1 is thus increased little or not at all by the introduction of coarse alternative solid fuels. The calorific value of coarse alternative solid fuels is efficiently exploited. Clinker production costs are reduced.

1. A clinker production plant (1) comprising:
a preheating unit (2), in which raw material is preheated;
a calcination unit (3), in which the preheated raw material is at least partially decarbonated;
a kiln (4) in which the preheated and at least partially decarbonated raw material is baked;
a cooler (5) in which the fired kiln material is cooled by cooling air;
plant in which the calcination assembly comprises a reactor (8) to calcinate by combustion a solid so-called alternative fuel, the calcination reactor (8) being arranged, according to the direction of flow of the gases, between the preheating assembly (2) and the kiln (4), and being connected to the cooler (5) so that:
at least part of the combustion fumes from the kiln (4) pass at least partly through the calcination reactor (8) before entering the preheating unit (2),
a tertiary gas flow comprising at least in part air leaving the cooler (5) passes at least in part through the calcination reactor (8) before entering the preheating unit (2),
and wherein the calcination reactor (8) comprises a system for controlling the residence time of the alternative solid fuel in the calcination reactor (8).

2. The plant according to claim 1 comprising a tertiary flow rate adjustment system (13) configured to ensure, in the calcination reactor (8), a balance between the supply of oxygen necessary for the combustion reaction and the reduction of the NOx produced in the kiln (4).

3. The plant (1) according to claim 1, wherein the calcination reactor (8) is a rotary kiln, where the alternative solid fuel residence time control system is a system for controlling the rotational speed and/or slope of the calcination reactor (8).

4. The plant (1) according to claim 1, wherein the preheating unit (2) comprises at least one cyclone preheater.

5. The plant according to claim 1, in which the calcination unit (3) furthermore comprises an additional calcination reactor (10) supplied with fuel, the additional calcination reactor (10) being arranged between the calcination reactor (8) and the preheating unit (2) in the direction of gas flow, so that at least some of the fumes leaving the calcination reactor (8) pass through the additional calcination reactor (10) before entering the preheating unit (2).

6. Installation (1) according to claim 1, in which the calcination assembly (3) furthermore comprises an auxiliary calcination reactor (11), supplied with a fuel, the auxiliary reactor (11) being connected to the cooler (5) upstream of the calcination reactor (8) in the direction of flow of the gases, so that the tertiary gas flow supplying the calcination reactor (8) comprises at least some of the fumes leaving the auxiliary reactor (11).

7. A method for producing clinker in a plant (1) according to claim 1, said method comprising:
preheating the raw material in the preheating unit (2);
decarbonating the preheated material in the calcination unit (3);
baking the preheated and decarbonated material in the kiln (4);
cooling the fired material in the cooler, the cooling being carried out by means of cooling air; the method further comprising:
feeding the calcination reactor (8) with at least part of the kiln (4) fumes and a tertiary gas stream comprising at least part of the cooling air leaving the cooler (5);
combusting in the calcination reactor (8) of a solid alternative fuel and the adjustment of the residence time of the solid alternative fuel in the calcination reactor (8);
recovering the fumes from the calcination reactor (8) to feed the preheating unit (2).

8. The method according to claim 7, wherein the solid alternative fuel is a solid fuel comprising particles having a characteristic size greater than 20 mm.

9. The method according to claim 7, wherein the solid alternative fuel is a solid fuel comprising particles having a characteristic size greater than 80 mm.

10. The method according to claim 7, wherein the tertiary gas flow to the calcination reactor (8) can be controlled so as to achieve a balance between the supply of oxygen needed for the combustion reaction and the reduction of NOx produced in the kiln (4).

11. The plant (1) according to claim 2, wherein the calcination reactor (8) is a rotary kiln, where the alternative solid fuel residence time control system is a system for controlling the rotational speed and/or slope of the calcination reactor (8).

12. The plant (1) according to claim 2, wherein the preheating unit (2) comprises at least one cyclone preheater.

13. The plant (1) according to claim 3, wherein the preheating unit (2) comprises at least one cyclone preheater.

14. The plant according to claim 2, in which the calcination unit (3) furthermore comprises an additional calcination reactor (10) supplied with fuel, the additional calcination reactor (10) being arranged between the calcination reactor (8) and the preheating unit (2) in the direction of gas flow, so that at least some of the fumes leaving the calcination reactor (8) pass through the additional calcination reactor (10) before entering the preheating unit (2).

15. The plant according to claim 3, in which the calcination unit (3) furthermore comprises an additional calcination reactor (10) supplied with fuel, the additional calcination reactor (10) being arranged between the calcination reactor (8) and the preheating unit (2) in the direction of gas flow, so that at least some of the fumes leaving the calcination reactor (8) pass through the additional calcination reactor (10) before entering the preheating unit (2).

16. The plant according to claim 4, in which the calcination unit (3) furthermore comprises an additional calcination reactor (10) supplied with fuel, the additional calcination reactor (10) being arranged between the calcination reactor (8) and the preheating unit (2) in the direction of gas flow, so that at least some of the fumes leaving the calcination reactor (8) pass through the additional calcination reactor (10) before entering the preheating unit (2).

17. Installation (1) according to claim 2, in which the calcination assembly (3) furthermore comprises an auxiliary calcination reactor (11), supplied with a fuel, the auxiliary reactor (11) being connected to the cooler (5) upstream of the calcination reactor (8) in the direction of flow of the gases, so that the tertiary gas flow supplying the calcination reactor (8) comprises at least some of the fumes leaving the auxiliary reactor (11).

18. Installation (1) according to claim 3, in which the calcination assembly (3) furthermore comprises an auxiliary calcination reactor (11), supplied with a fuel, the auxiliary reactor (11) being connected to the cooler (5) upstream of the calcination reactor (8) in the direction of flow of the gases, so that the tertiary gas flow supplying the calcination reactor (8) comprises at least some of the fumes leaving the auxiliary reactor (11).

19. Installation (1) according to claim 4, in which the calcination assembly (3) furthermore comprises an auxiliary calcination reactor (11), supplied with a fuel, the auxiliary reactor (11) being connected to the cooler (5) upstream of the calcination reactor (8) in the direction of flow of the gases, so that the tertiary gas flow supplying the calcination reactor (8) comprises at least some of the fumes leaving the auxiliary reactor (11).

20. Installation (1) according to claim 5, in which the calcination assembly (3) furthermore comprises an auxiliary calcination reactor (11), supplied with a fuel, the auxiliary reactor (11) being connected to the cooler (5) upstream of the calcination reactor (8) in the direction of flow of the gases, so that the tertiary gas flow supplying the calcination reactor (8) comprises at least some of the fumes leaving the auxiliary reactor (11).
